(19) United States
(12) Patent Application Publication
(10) Pub. No.: US 2018/0106310 A1
(43) Pub. Date: Apr. 19, 2018

(54) DISC BRAKE DEVICE

(71) Applicant: ADVICS CO., LTD., Kariya-shi, Aichi-ken (JP)

(72) Inventor: Tomohiro YOKOYAMA, Toyota-shi, Aichi-ken (JP)

(73) Assignee: ADVICS CO., LTD., Kariya-shi, Aichi-ken (JP)

(21) Appl. No.: 15/556,366

(22) PCT Filed: Mar. 31, 2016
(86) PCT No.: PCT/JP2016/060765

§ 371 Date: Sep. 7, 2017

(30) Foreign Application Priority Data
Mar. 31, 2015 (JP) 2015-074262

(51) Int. Cl. F16D 55/228; F16D 65/095

(52) U.S. Cl. CPC F16D 55/228; F16D 65/095

(57) ABSTRACT

A disc brake device is provided with a first pressing member disposed between a caliper and a pair of brake pads. The first pressing member has: a base section mounted to the caliper; a pair of plate spring sections extending from the base section toward one circumferential side of a disc rotor and toward the pair of brake pads and pressing the pair of brake pads inward radially; and an extension section extending from the base section toward said one circumferential side and supported by the caliper from the outside radially of the disc rotor.

### TECHNICAL FIELD

The present invention relates to a disc brake device.

### BACKGROUND ART

Conventionally, a disc brake device having a configuration in which a biasing member for applying a load to a brake pad is supported by a caliper is known.

### CITATIONS LIST

### Patent Literatures

Patent Literature 1: Unexamined Japanese Patent Publication No. 2011-241951

Patent Literature 2: U.S. Pat. No. 8,016,085

### SUMMARY OF INVENTION

### Technical Problems

In the disc brake device, it is meaningful if the attachment state of the biasing member to the caliper and biasing force of the biasing member can be stabilized. It is therefore an object of the present invention to provide a disc brake device which is easy to stabilize the attachment state of the biasing member to the caliper and the biasing force.

The present invention provides a disc brake device including: for example, a caliper; a disc rotor rotating with respect to the caliper; a pair of brake pads positioned in the axial direction of the disc rotor with the disc rotor interposed therebetween; a pressing portion disposed on the caliper and pressing the pair of brake pads toward the disc rotor; an inner supporting portion disposed in each of the inner parts of the pair of brake pads in the radial direction of the disc rotor; an outer supporting portion disposed in each of the outer parts of the pair of brake pads in the radial direction of the disc rotor; an inner spindle supported by the caliper and supporting the inner supporting portion of each of the pair of brake pads; an outer spindle supported by the caliper and supporting the outer supporting portion of each of the pair of brake pads to make it possible to oscillate the pair of brake pads around the inner spindle; and a first biasing member positioned radially outside the pair of brake pads and interposed between the caliper and the pair of brake pads, wherein the first biasing member includes a base portion attached to the caliper, a pair of spring portions extending from the base portion in one of the circumferential directions of the disc rotor and extending toward the pair of brake pads and pressing the pair of brake pads inward in the radial direction, and an extension portion extending from the base portion in one of the circumferential directions and supported by the caliper from the radial outside of the disc rotor. Thus, for example, since the extension portion of the first biasing member is supported by the caliper from the outside in the radial direction of the disc rotor, the reaction force of the elastic force of the pair of spring portions pressing the pair of brake pads makes it possible to inhibit the first biasing member from rotating about the base portion. Therefore, the attachment state of the first biasing member to the caliper and the biasing force can be easily stabilized.

In the disc brake device, for example, the extension portion is positioned between the pair of spring portions. Therefore, for example, the extension portion can receive the respective reaction forces of the elastic forces of the pair of spring portions pressing the pair of brake pads in a well-balanced manner.

In the disc brake device, for example, the caliper has a restricting portion for supporting the extension portion in the axial direction. Therefore, for example, the movement of the first biasing member in the axial direction of the disc rotor can be restricted.

In the disc brake device, for example, the spring portion has a curved portion that comes into contact with the brake pad. Therefore, for example, stress concentration in the portion pressed by the spring portion in the brake pad can be suppressed.

In the disc brake device, for example, the spring portion has a bent portion between the base portion and a contact portion of the brake pad. Therefore, the stress can be distributed in the spring portion.

Further, in the disc brake device, for example, the caliper has a pair of facing portions spaced apart from each other in the axial direction and a connecting portion connecting the pair of facing portions, and the extension portion is supported by the connecting portion. Therefore, a configuration for supporting the extension portion in the pair of facing portions need not be disposed.

In the disc brake device, for example, the base portion, the pair of spring portions, and the extension portion are integrally formed. Therefore, an increase in number of parts of the disc brake device can be suppressed.

Further, the disc brake device includes, for example, a second biasing member which is provided separately from the first biasing member and presses the outer spindle inward in the radial direction. Therefore, the outer spindle can be pressed by the second biasing member. Further, since the first biasing member and the second biasing member are separate bodies (separate parts), the spring portion and the like can be easily manufactured with high precision.

### BRIEF DESCRIPTION OF THE DRAWINGS

FIG. 1 is a front view of a disc brake device according to an embodiment.

FIG. 2 is a plan view of the disc brake device according to the embodiment.

FIG. 3 is a side view of the disc brake device according to the embodiment.

FIG. 4 is a cross-sectional view taken along a line IV-IV in FIG. 3.

FIG. 5 is a cross-sectional view taken along a line V-V in FIG. 3.

FIG. 6 is a cross-sectional view taken along a line VI-VI in FIG. 3.

FIG. 7 is a perspective view of a part of the disc brake device according to the embodiment.

FIG. 8 is a perspective view of a biasing member according to the embodiment.

FIG. 9 is a plan view of the biasing member according to the embodiment.

FIG. 10 is a side view of the biasing member according to the embodiment.

FIG. 11 is a front view of the biasing member according to the embodiment.

FIG. 12 is a perspective view of the biasing member according to the embodiment.

FIG. 13 is a plan view of the biasing member according to the embodiment.

FIG. 14 is a side view of the biasing member according to the embodiment.

FIG. 15 is a front view of the biasing member according to the embodiment.

FIG. 16 is a diagram showing a part of the cross section taken along a line XVI-XVI in FIG. 3.

FIG. 17 is an enlarged view of a part XVII in FIG. 5.

### DESCRIPTION OF EMBODIMENT

An exemplary embodiment of the present invention is disclosed below. The configuration of the embodiment described below and the operation and result (effect) brought about by the configuration are just examples. The present invention can also be achieved by other than the configuration disclosed in the following embodiment. Further, according to the present invention, at least one of various effects (including derivative effects) obtained by the configuration can be obtained. In the following description, an X direction, a Y direction, and a Z direction are defined for the sake of convenience. The X direction, the Y direction, and the Z direction are orthogonal to each other.

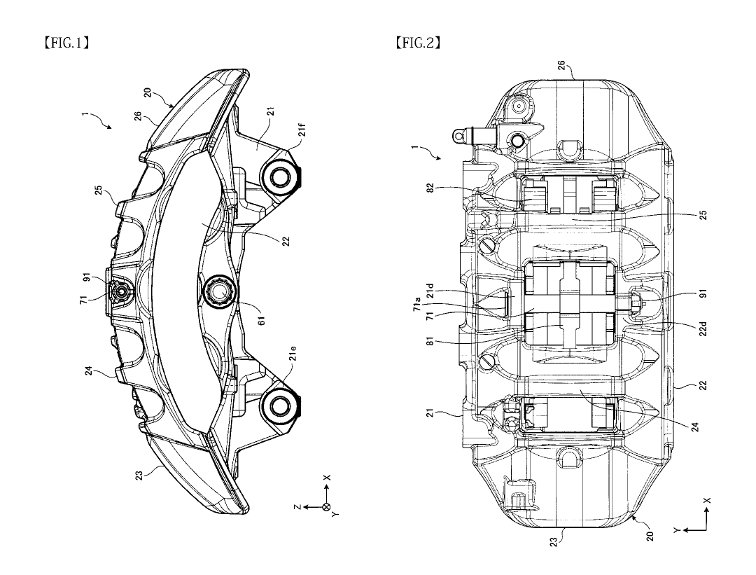

This embodiment is an example in which the disc brake device of the present invention is applied to a piston-opposed type (fixed type) disc brake device for a vehicle. As shown in FIGS. 1 to 7, a disc brake device 1 of the embodiment includes a disc rotor 10 (FIG. 4) assembled to an axle hub (rotor (not shown)) and rotating integrally with a wheel (not shown), a caliper 20 disposed to straddle a part of the outer circumferential part of the disc rotor 10, six pistons 31 to 36 assembled to the caliper 20, an inner brake pad 40, an outer brake pad 50. In addition, the disc brake device 1 includes an inner spindle 61 and an outer spindle 71 disposed on the caliper 20, and biasing members 81 and 82. In the following description, the axial direction of the disc rotor 10 is also referred to as a rotor axial direction, the radial direction of the disc rotor 10 is referred to as a rotor radial direction, and the circumferential direction of the disc rotor 10 is also referred to as a rotor circumferential direction.

The disc rotor 10 shown in FIG. 4 rotates with respect to the caliper 20. The disc rotor 10 has an annular braked surface (not shown) which can be clamped between a lining 42 of the inner brake pad 40 and a lining 52 of the outer brake pad 50. In addition, the disc rotor 10 is braked in rotation as the braked surface is clamped by the lining 42 of the inner brake pad 40 and the lining 52 of the outer brake pad 50 during braking. When the wheel rotates forward, the disc rotor 10 rotates (forward rotation) in the clockwise direction in FIG. 4 integrally with the wheel, the left side in FIG. 4 becomes a turn-in side (leading side), the right side of FIG. 4 becomes a turn-out side (trailing side). In the following description, the turn-out side in the rotor circumferential direction is defined as one side in the rotor circumferential direction, and the turn-in side in the rotor circumferential direction is defined as the other side in the rotor circumferential direction.

As shown in FIGS. 1 to 6, the caliper 20 includes an inner housing portion 21 and an outer housing portion 22 which are spaced apart from each other in the rotor axial direction, and four connecting portions 23, 24, 25, and 26 which connect the inner housing portion 21 and he outer housing portion 22. The caliper 20 straddles the outer circumference of a part of the disc rotor 10 in a state where a part of the disc rotor 10 is positioned between the inner housing portion 21 and the outer housing portion 22. The inner housing portion 21 and the outer housing portion 22 are examples of a pair of facing parts.

The inner housing portion 21 is disposed on the inner side of the disc rotor 10 and has three cylinders. Three cylinders are arranged at predetermined intervals in the rotor circumferential direction. Each cylinder is formed to extend in the rotor axial direction.

In addition, the inner housing portion 21 has supporting portions 21c and 21d. The supporting portion 21c supports the inner spindle 61, and the supporting portion 21d supports the outer spindle 71.

Further, the inner housing portion 21 has a pair of attachment portions 21e and 21f extending inwardly in the rotor radial direction at the radially inner end of the rotor. The inner housing portion 21 is configured to be attached to the vehicle body side (support body) with bolts (not shown) at the attachment portions 21e and 21f.

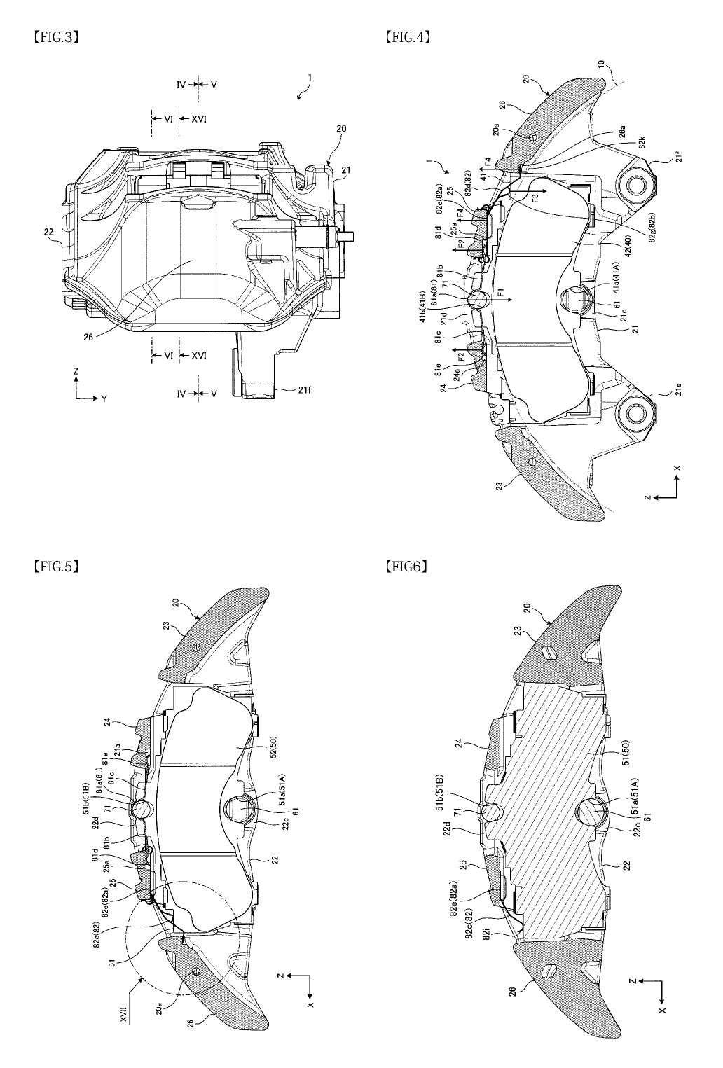

As shown in FIG. 5, the outer housing portion 22 is disposed on the outer side of the disc rotor 10, and has three cylinders like the inner housing portion 21. The outer housing portion 22 has supporting portions 22c and 22d like the supporting portions 21c and 21d of the inner housing portion 21. The supporting portion 22c supports the inner spindle 61, and the supporting portion 22d supports the outer spindle 71.

Each of the pistons 31 to 36 shown in FIG. 7 is liquid-tightly assembled to each cylinder so as to be oscillated in the axial direction of the rotor as well known, and the pistons 31 to 36 are opposed to each other across the disc rotor 10. When the disc rotor 10 is braked, the pistons 31 to 36 are pressed by hydraulic oil supplied from a brake master cylinder (not shown) to oil chambers formed between the pistons 31 to 36 and the respective cylinders, so that the inner brake pad 40, and the outer brake pad 50 can be pressed toward the disc rotor 10 in the rotor axial direction. The oil chambers communicate with each other through an oil passage 20a disposed in the caliper 20. The pistons 31 to 36 and the cylinders constitute a pressing portion 37 which is disposed on the caliper 20 to press the inner brake pad 40 and the outer brake pad 50 toward the disc rotor 10.

The inner brake pad 40 and the outer brake pad 50 shown in FIGS. 4, 5, and 7 and the like are positioned to interpose the disc rotor 10 therebetween in the rotor axial direction. The inner brake pad 40 and the outer brake pad 50 are examples of a pair of brake pads.

As shown in FIGS. 4 and 7, the inner brake pad 40 has a back plate 41 and the lining 42 fixed to the back plate 41. The inner brake pad 40 is disposed on the inner housing portion 21 side of the caliper 20 and assembled to the inner spindle 61 and the outer spindle 71 on the back plate 41 such that the inner brake pad 40 can rotate, i.e., oscillate around the axis center of the inner spindle 61 by a predetermined amount (slight amount).

The back plate 41 is formed in a flat plate shape as shown in FIG. 4. The back plate 41 has an inner portion 41A which extends inward in the rotor radial direction from the lining 42 and on which a V-shaped inner circumferential torque receiving surface 41a is formed. In addition, the back plate 41 has an outer portion 41B which extends outward in the rotor radial direction from the lining 42 and has a V-shaped outer circumferential torque receiving surface 41b formed thereon. The inner circumferential torque receiving surface 41a is disposed on the inner side in the rotor radial direction of the back plate 41 and at the center in a rotor circumferential direction. The inner circumferential torque receiving surface 41a is engaged with the inner spindle 61. The outer circumferential torque receiving surface 41b is disposed on the outer side in the rotor radial direction of the back plate 41 and at the center in the rotor circumferential direction. The outer circumferential torque receiving surface 41b is engaged with the outer spindle 71. The inner circumferential torque receiving surface 41a is an example of an inner supporting portion disposed in the inner part of the inner brake pad 40 in the rotor radial direction, and the outer circumferential torque receiving surface 41b is an example of an outer supporting portion disposed in the outer part of the inner brake pad 40 in the rotor radial direction.

As shown in FIG. 7, the lining 42 is attached to the surface of the back plate 41 on the disc rotor 10 side, and an inner shim ISa and an outer shim ISb are attached to a surface opposite to the disc rotor 10 of the back plate 41, i.e., on a surface on pistons 31, 32, and 33 side.

The lining 42 is formed in a substantially fan shape so as to extend in the rotor circumferential direction. The lining 42 is slidably pressed against the braked surface of the disc rotor 10 by causing the pistons 31, 32, and 33 to press the back plate 41 via the inner shim ISa and the outer shim ISb to make it possible to brake the disc rotor 10. During normal rotation braking of the disc rotor 10 (when the disc rotor is braked during forward travel of the vehicle), frictional force is applied to the lining 42 slidably pressed against the braked surface of the disc rotor 10 from the turn-in side to the turn-out side in the rotor circumferential direction.

As shown in FIGS. 5, 6 and 7, the outer brake pad 50 has a back plate 51 and the lining 52 fixed to the back plate 51. The outer brake pad 50 is disposed on the outer housing portion 22 side of the caliper 20 and assembled to the inner spindle 61 and the outer spindle 71 on the back plate 51 such that the outer brake pad 50 can rotate, i.e., oscillate around the axis center of the inner spindle 61 by a predetermined amount (slight amount).

As shown in FIGS. 5 and 6, the back plate 51 is formed in a flat plate shape. The back plate 51 has an inner portion 51A which extends inward in the rotor radial direction from the lining 52 and has a V-shaped inner circumferential torque receiving surface 51a formed thereon. Further, the back plate 51 has an outer portion 51B which extends outward in the rotor radial direction from the lining 52 and has a V-shaped outer circumferential torque receiving surface 51b formed thereon. The inner circumferential torque receiving surface 51a is disposed on the inner side in the rotor radial direction of the back plate 51 and at the center in the rotor circumferential direction. The inner circumferential torque receiving surface 51a is engaged with the inner spindle 61. The outer circumferential torque receiving surface 51b is disposed on the outer side in the rotor radial direction of the back plate 51 and at the center in the rotor circumferential direction. The outer circumferential torque receiving surface 51b is engaged with the outer spindle 71. The inner circumferential torque receiving surface 51a is an example of an inner supporting portion disposed in the inner part of the outer brake pad 50 in the rotor radial direction, and the outer circumferential side torque receiving surface 51b is an example of an outer supporting portion disposed on the outer part of the outer brake pad 50 in the rotor radial direction.

As shown in FIG. 7, the lining 52 is attached to the surface of the back plate 51 on the disc rotor 10 side, and an inner shim OSa and an outer shim OSb are attached to a surface opposite to the disc rotor 10 of the back plate 51, i.e., on a surface on the pistons 34, 35, and 36 side.

The lining 52 is formed in a substantially fan shape so as to extend in the rotor circumferential direction. The lining 52 is slidably pressed against the braked surface of the disc rotor 10 by causing the pistons 34, 35, and 36 to press the back plate 51 via the inner shim OSa and the outer shim OSb to make it possible to brake the disc rotor 10. During normal rotation braking of the disc rotor 10 (when the disc rotor is braked during forward travel of the vehicle), frictional force is applied to the lining 52 slidably pressed against the braked surface of the disc rotor 10 from the turn-in side to the turn-out side in the rotor circumferential direction.

As shown in FIGS. 1 and 3 to 7, the inner spindle 61 extends in the rotor axial direction and is screwed to each of the supporting portions 21c and 22c of the caliper 20. The inner spindle 61 is supported by the caliper 20 and supports the inner circumferential torque receiving surfaces 41a and 51a of the inner brake pad 40 and the outer brake pad 50, respectively.

As shown in FIGS. 1 to 7, the outer spindle 71 extends in the rotor axial direction and is inserted into each of the supporting portions 21d and 22d of the caliper 20. The outer spindle 71 is prevented from slipping off from the caliper 20 by a flange 71a (FIG. 2) disposed on the outer spindle 71 and a retaining member 91 (FIG. 2). The outer spindle 71 is supported by the caliper 20 and supports the outer circumferential torque receiving surfaces 41b and 51b of the inner brake pad 40 and the outer brake pad 50 to make it possible to oscillate the inner brake pad 40 and the outer brake pad 50 around the inner spindle 61.

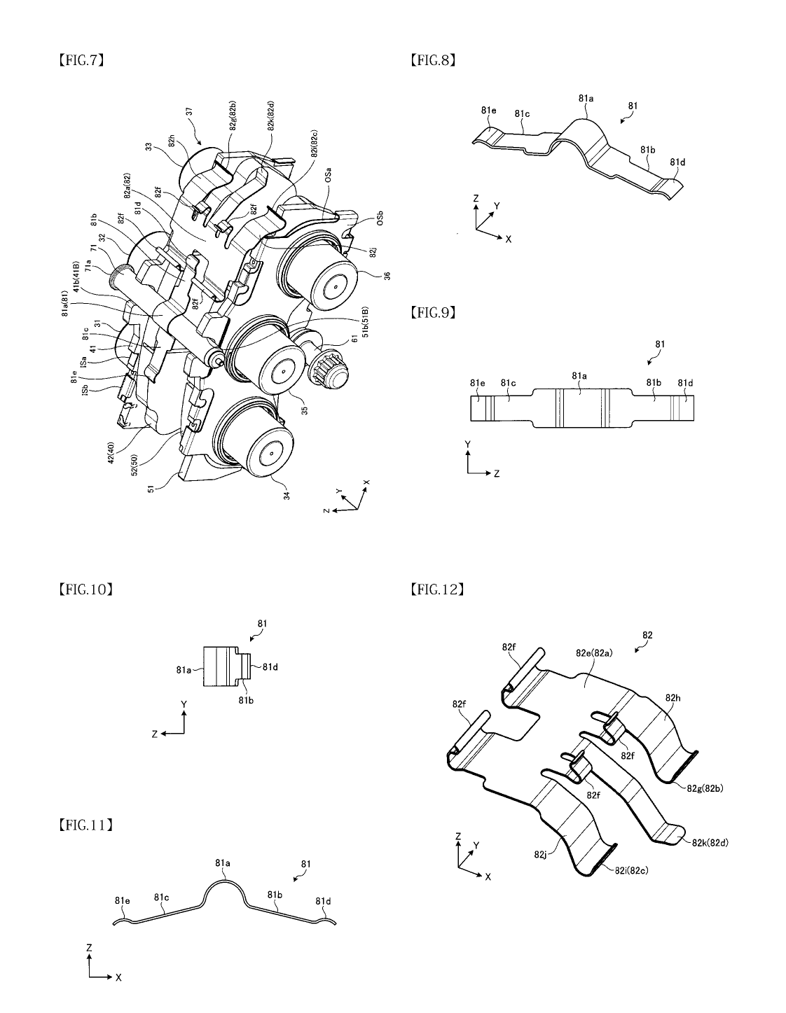

As shown in FIGS. 4 and 5, a biasing member 81 is interposed between the caliper 20 and the outer spindle 71, presses the outer spindle 71 inward in the rotor radial direction to hold the outer spindle 71. Specifically, as shown in FIGS. 8 to 11, the biasing member 81 has a base portion 81a and a pair of arm portions 81b and 81c so as to be configured as a leaf spring. The base portion 81a is formed in a curved shape which covers the outer part in the rotor radial direction of the outer spindle 71 and overlaps the outer part of the outer spindle 71 in the rotor radial direction. The arm portion 81b extends from the base portion 81a toward the turn-out side in the rotor circumferential direction and is caught by a restricting portion 25a disposed in a recessed shape in the inner part of a connecting portion 25 in the rotor radial direction and is supported by the connecting portion 25. The movement of an arm portion 81b in the rotor radial direction and the rotor axial direction is restricted by the restricting portion 25a. The arm portion 81b has a curved portion 81d at the distal end part thereof, and the curved portion 81d is in contact with the restricting portion 25a. On the other hand, the arm portion 81c extends from the base portion 81a on the turn-in side in the rotor circumferential direction, is caught by a restricting portion 24a disposed in a recessed shape in the inner part of a connecting portion 24 in the rotor radial direction, and is supported by the connecting portion 24. The movement of the arm portion 81c in the rotor radial direction and the rotor axial direction is restricted by the restricting portion 24a. The arm portion 81c has a curved portion 81e at the distal end part thereof, and the curved portion 81e is in contact with the restricting portion 24a. The biasing member 81 having the above configuration generates pressing force which presses the outer spindle 71 inward in the rotor radial direction. The reaction force at this time acts on the connecting portions 24 and 25. The direction of the pressing force is indicated by an arrow F1 in FIG. 4 and the direction of the reaction force is indicated by an arrow F2 in FIG. 4. The biasing member 81 is an example of a second biasing member.

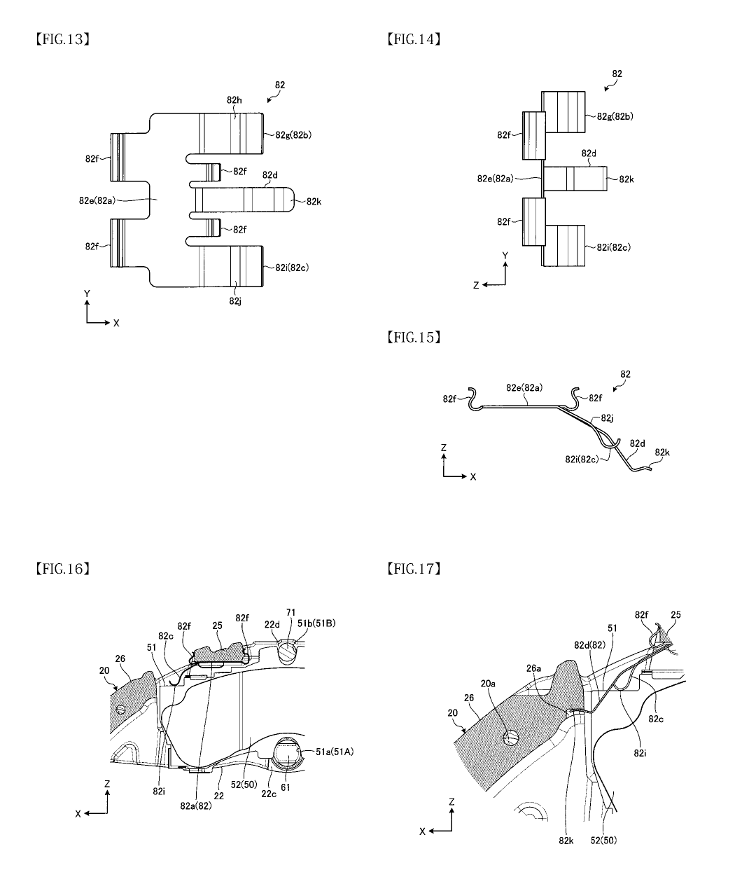

As shown in FIGS. 4 to 7, a biasing member 82 is positioned outside the inner brake pad 40 and the outer brake pad 50 in the rotor radial direction, and interposed between the caliper 20, the inner brake pad 40, and the outer brake pad 50. The biasing member 82 presses the inner brake pad 40 and the outer brake pad 50 inward in the rotor radial direction. Specifically, as shown in FIGS. 12 to 15, the biasing member 82 has a base portion 82a,a pair of leaf spring portions 82b and 82c,and an extension portion 82d. The base portion 82a,the pair of leaf spring portions 82b and 82c,and the extension portion 82d are integrally formed. The pair of leaf spring portions 82b and 82c are examples of a pair of spring portions.

As shown in FIG. 16, the base portion 82a is attached to the connecting portion 25 of the caliper 20. The base portion 82a has a wall portion 82e and four (plurality of) mounting arms 82f. The wall portion 82e extends in the rotor axial direction and overlaps the inner surface of the connecting portion 25 in the rotor radial direction (FIGS. 4 and 5). Two of the mounting arms 82f are disposed at one end in the rotor circumferential direction of the wall portion 82e and extend outward in the rotor radial direction, and the other two mounting arms 82f are disposed at the other end in the rotor circumferential direction of the wall portion 82e and extends to the outer side in the rotor radial direction. Each of the mounting arms 82f is configured as a leaf spring having a curved shape. The four mounting arms 82f sandwich the connecting portion 25 in the rotor circumferential direction by their elastic force to attach the base portion 82a to the connecting portion 25.

The pair of leaf spring portions 82b and 82c are positioned at intervals in the rotor axial direction. The pair of leaf spring portions 82b and 82c extend from the base portion 82a on the turn-out side in the rotor circumferential direction and extend toward the inner brake pad 40 and the outer brake pad 50. Two of the mounting arms 82f are positioned between the pair of leaf spring portions 82b and 82c. The leaf spring portion 82b has a curved portion 82g which is in contact with the back plate 41 of the inner brake pad 40 at the distal end part thereof. The curved portion 82g is formed in a convex shape toward the inner side in the rotor radial direction. Further, the leaf spring portion 82b has a bent portion 82h between the base portion 82a and a contact portion (curved portion 82g) to the inner brake pad 40. The bent portion 82h is formed in a convex shape toward the outer side in the rotor radial direction. The leaf spring portion 82c has a curved portion 82i in contact with the back plate 51 of the outer brake pad 50 at a distal end part thereof. The curved portion 82i is formed in a convex shape toward the inner side in the rotor radial direction. Further, the leaf spring portion 82c has a bent portion 82j between the base portion 82a and a contact portion (curved portion 82i) to the outer brake pad 50. The bent portion 82j is formed in a convex shape toward the outer side in the rotor radial direction. With the above configuration, the leaf spring portion 82b presses the inner brake pad 40 inward in the rotor radial direction, and the leaf spring portion 82c presses the outer brake pad 50 inward in the rotor radial direction.

The widths of at least the curved portions 82g and 82i in the rotor axial direction in the leaf spring portions 82b and 82c are almost equal to or larger than a width corresponding to a value obtained by adding the thicknesses of the back plates 41 and 51 in the rotor axial direction to the thicknesses of the new (unworn) linings 42 and 52 in the rotor axial direction. As a result, even though the positions of the back plates 41 and 51 in the axial direction are displaced due to wear of the linings 42 and 52, the leaf spring portions 82b and 82c are brought into contact with the back plates 41 and 51 to make it possible to cause the leaf spring portions 82b and 82c to press the back plates 41 and 51.

The extension portion 82d is positioned between the pair of leaf spring portions 82b and 82c. The extension portion 82d extends from the base portion 82a on the turn-out side in the rotor circumferential direction. A distal end portion 82k of the extension portion 82d is bent outward in the rotor radial direction. As shown in FIG. 17, the distal end portion 82k is caught by a restricting portion 26a disposed in a recessed shape in the inner part of the connecting portion 26 in the rotor radial direction and is supported by the restricting portion 26a from outer side in the rotor radial direction There. The movement of the distal end portion 82k in the rotor radial direction and the rotor axial direction is restricted by the restricting portion 26a.

In the biasing member 82 having the above configuration, the leaf spring portion 82b generates pressing force (elastic force) pressing (biasing) the outer circumference of the turn-out side part of the back plate 41 inward in the rotor radial direction such that the turn-in side part of the inner brake pad 40 is located outside the turn-out side part in the rotor radial direction. On the other hand, the leaf spring portion 82c generates pressing force (elastic force) pressing (biasing) the outer circumference of the turn-out side part of the back plate 51 inward in the rotor radial direction such that the turn-in side part of the outer brake pad 50 is located outside the turn-out side part in the rotor radial direction. The reaction force at this time acts on the connecting portion 25. The direction of the pressing force is indicated by an arrow F3 in FIG. 4, and the direction of the reaction force is indicated by an arrow F4 in FIG. 4.

In the above configuration, the back plate 41 of the inner brake pad 40 is engaged with the inner spindle 61 without any gap at two positions between the 1 o'clock position and the 2 o'clock position and between the 10 o'clock position to the 11 o'clock position with respect to the inner spindle 61 in FIG. 4 on the inner circumference side torque receiving surface 41a and engaged with the outer spindle 71 without any gap at a position between the 7 o'clock position and the 8 o'clock position with respect to the outer spindle 71 in FIG. 4 on the outer circumferential torque receiving surface 41b.

On the other hand, the back plate 51 of the outer brake pad 50 is engaged with the inner spindle 61 without any gap at two positions between the 1 o'clock position and the 2 o'clock position and between the 10 o'clock position to the 11 o'clock position with respect to the inner spindle 61 in FIG. 5 on the inner circumferential torque receiving surface 51a and engaged with the outer spindle 71 without any gap at a position between the 4 o'clock position and the 5 o'clock position with respect to the outer spindle 71 in FIG. 5 on the outer circumferential torque receiving surface 51b.

In the disc brake device 1 having the above configuration, when hydraulic oil is supplied from a brake master cylinder (not shown) to each of the oil chambers in accordance with stepping on of a brake pedal (not shown), the pistons 31 to 36 are pressed toward the disc rotor 10 to press the inner brake pad 40 and the outer brake pad 50 toward the disc rotor 10. As a result, the linings 42 and 52 of the inner brake pad 40 and the outer brake pad 50 are slidably pressed against the braked surface of the disc rotor 10 to brake the disc rotor 10. When the stepping on of a brake pedal (not shown) is canceled and the hydraulic oil is discharged from each of the oil chambers toward a brake master cylinder (not shown), the braking of the above-described disc rotor 10 is canceled.

In the disc brake device 1 having the above configuration, when the disc rotor 10 is braking (during normal rotation braking), torque in braking can be received at a total of three positions, i.e., two engaged portions between the V-shaped inner circumferential torque receiving surfaces 41a and 51a of the inner brake pad 40 and the outer brake pad 50 and the inner spindle 61 and an engaged portion between the V-shaped outer circumferential torque receiving surfaces 41b and 51b of the inner brake pad 40 and the outer brake pad 50 and the outer spindle 71. Therefore, the behaviors of the inner brake pad 40 and the outer brake pad 50 are stabilized as compared with the case where the torque in braking is received on an unstable plane. Therefore, brake squeal caused by the unstable behavior in braking can be suppressed. In addition, a reduction in area (machining area) of a part receiving torque in braking can be greater than that obtained when the torque in braking is received by an unstable plane to make it possible to reduce the machining cost.

Further, in this embodiment, the outer circumferences of the turn-out side parts of the back plates 41 and 51 are biased by the biasing member 82 inward in the rotor radial direction such that the turn-in side parts of the inner brake pad 40 and the outer brake pad 50 are set so as to be located outside the turn-out side parts thereof in the rotor radial direction. Therefore, the three points receiving the torque in braking are previously engaged (brought into contact) by the biasing force of the biasing member 82 before braking. Therefore, when the disc rotor 10 is not braked, instability between the inner spindle 61 and the outer spindle 71 attached to the caliper 20 and the brake pads 40 and 50 can be suppressed.

As described above, in the embodiment, the extension portion 82d of the biasing member 82 is supported on the caliper 20 from the outer side in the rotor radial direction. Thus, the biasing member 82 can be inhibited from rotating about the base portion 82a by the reaction force of the elastic force of the pair of leaf spring portions 82b and 82c pressing the inner brake pad 40 and the outer brake pad 50. Therefore, the attachment state of the biasing member 82 to the caliper 20 and the biasing force are stabilized.

Further, in the embodiment, the extension portion 82d is positioned between the pair of leaf spring portions 82b and 82c. Therefore, the extension portion 82d can receive the respective reaction forces of the elastic forces of the pair of leaf spring portions 82b and 82c pressing the inner brake pad 40 and the outer brake pad 50 in a well-balanced manner.

Further, in the embodiment, the caliper 20 has the restricting portion 26a which supports the extension portion 82d in the rotor axial direction. Therefore, the movement of the biasing member 82 in the rotor axial direction can be suppressed.

Further, in the embodiment, the leaf spring portions 82b and 82c have the curved portions 82g and 82i contacting the inner brake pad 40 and the outer brake pad 50, respectively. Therefore, for example, stress concentration can be suppressed on the part pressed by the leaf spring portions 82b and 82c in the inner brake pad 40 and the outer brake pad 50.

Further, in the embodiment, the leaf spring portions 82b and 82c have bent portions 82h and 82j between the base portion 82a and the curved portions 82g and 82i which are contact portions between the inner brake pad 40 and the outer brake pad 50. Therefore, stress can be distributed on the leaf spring portions 82b and 82c.

Further, in the embodiment, the extension portion 82d is supported by the connecting portion 26. Therefore, a configuration for supporting the extension portion 82d need not be disposed in the pair of inner housing portion 21 and outer housing portion 22.

Further, in the embodiment, the base portion 82a,the pair of leaf spring portions 82b and 82c,and the extension portion 82d are integrally formed. Therefore, an increase in number of parts of the disc brake device 1 can be suppressed.

In addition, in the embodiment, the disc brake device 1 is provided with the biasing member 81 pressing the outer spindle 71 inward in the rotor radial direction. Therefore, the outer spindle 71 can be kept down by the biasing member 81. Further, since the biasing member 81 and the biasing member 82 are separate bodies (separate parts), the leaf spring portions 82b and 82c and the arm portions 81b and 81c,and the like can be manufactured with high accuracy.

Although the embodiment of the present invention has been exemplified above, the above embodiment is merely an example, and it is not intended to limit the scope of the invention. The above embodiment can be performed in various other forms, and various omissions, substitutions, combinations, and changes can be made without departing from the scope of the invention. Further, the embodiment can be performed such that the specifications (structures, types, directions, shapes, sizes, lengths, widths, thicknesses, heights, numbers, arrangements, positions, materials, and the like) such as the configurations and shapes can be appropriately changed. In addition, a plurality of embodiments can be performed such that the configurations among a plurality of embodiments are partially replaced with each other.

For example, in the above embodiment, the leaf spring portion has been described as an example of the spring portion of the second biasing member, but the present invention is not limited thereto. The spring portion of the second biasing member may be a rod spring portion or the like

The above embodiment explains the example in which the caliper 20 includes the inner housing portion 21 and the outer housing portion 22 and the connecting portions 23 to 26 connecting the inner housing portion 21 and the outer housing portion 22 to each other such that these portions are integrally formed. However, the invention is not limited to the embodiment. For example, the embodiment may be performed by employing a caliper in which the inner housing portion and the outer housing portion are divided by two in the rotor axial direction and connected by a plurality of connecting bolts.

The above embodiment is performed by the configuration in which three cylinders are formed in each of the inner housing portion 21 and the outer housing portion 22 of the caliper 20. However, the embodiment may be performed such that the number of cylinders formed in each of the inner housing portion and the outer housing portion of the caliper and the number of pistons assembled in the cylinders may be a number other than three.

1. A disc brake device comprising:
a caliper;
a disc rotor rotating with respect to the caliper;
a pair of brake pads positioned in the axial direction of the disc rotor with the disc rotor interposed therebetween;
a pressing portion disposed on the caliper and pressing the pair of brake pads toward the disc rotor;
an inner supporting portion disposed in each of the inner parts of the pair of brake pads in the radial direction of the disc rotor;
an outer supporting portion disposed in each of the outer parts of the pair of brake pads in the radial direction;
an inner spindle supported by the caliper and supporting the inner supporting portion of each of the pair of brake pads;
an outer spindle supported by the caliper and supporting the outer supporting portion of each of the pair of brake pads to make it possible to oscillate the pair of brake pads around the inner spindle; and
a first biasing member positioned outside the pair of brake pads in the radial direction and interposed between the inner surface of the caliper in the radial direction and the outer surface of the pair of brake pads in the radial direction,
wherein the first biasing member includes
a base portion attached to the caliper,
a pair of spring portions extending from the base portion in one of the circumferential directions of the disc rotor and extending toward the pair of brake pads and pressing the pair of brake pads inward in the radial direction, and
an extension portion extending from the base portion in one of the circumferential directions and supported by the caliper from the radial outside of the disc rotor.

2. (canceled)

3. The disc brake device according to claim 1, wherein the caliper has a restricting portion that supports the extension portion in the axial direction.

4. The disc brake device according to claim 1, wherein the spring portion has a curved portion which contacts the brake pad.

5. The disc brake device according to claim 1, wherein the spring portion has a bent portion between the base portion and a contact portion between the base portion and the brake pad.

6. (canceled)

7. (canceled)

8. The disc brake device according to claim 1, comprising a second biasing member which is disposed separately from the first biasing member and presses the outer spindle inward in the radial direction.

9. The disc brake device according to claim 1, wherein the caliper has a pair of facing portions spaced apart from each other in the axial direction and a connecting portion connecting the pair of facing portions,
the base portion is attached to the connecting portion.
